(19) United States
(12) Patent Application Publication
(10) Pub. No.: US 2004/0167977 A1
(43) Pub. Date: Aug. 26, 2004

(54) Method and system for monitoring streaming media flow

(76) Inventors: Christopher Paul Douglas, Loveland, CO (US); Chia-Chu Dorland, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/372,450

(22) Filed: Feb. 25, 2003

(51) Int. Cl. G06F 15/173

(52) U.S. Cl. 709/224

(57) ABSTRACT

In accordance with an exemplary embodiment, a method for monitoring streaming media flow in a computer network includes recording at least one address in an information packet, each at least one address corresponding to a location in the network where the information packet has been, and displaying a map showing a communication path in the network, the communication path being defined by the at least one address.

### RELATED APPLICATIONS

Copending U.S. application Ser. No. ______, entitled “METHOD AND SYSTEM FOR MONITORING RELATIONSHIPS BETWEEN CONTENT DEVICES IN A CONTENT DELIVERY NETWORK”, Attorney Docket No. 100110381-1 (032842-097), inventors Chris DOUGLAS, et al., filed in the U.S. Patent and Trademark Office on the same date as the present application, is hereby incorporated by reference. Copending U.S. application Ser. No. ______, entitled “METHOD AND APPARATUS FOR MONITORING A NETWORK”, Attorney Docket No. 100110378-1 (032842-099), inventors Chris DOUGLAS, et al., filed in the U.S. Patent and Trademark Office on the same date as the present application, is hereby incorporated by reference.

### BACKGROUND

Inktomi Corporation, Cisco Systems Inc., and CacheFlow (now Blue Coat Systems, Inc.) have manufactured various solutions for use in Content Delivery Networks (CDNs), including cache devices and Content Distribution Managers (CDMs), with accompanying software. Some of these solutions provide a management tool for homogeneous caches. For example, U.S. Pat. No. 6,263,371 assigned to CacheFlow describes aspects of streaming media in a network and is hereby incorporated by reference.

### SUMMARY

An exemplary method for monitoring streaming media flow in a computer network includes recording at least one address in an information packet, each at least one address corresponding to a location in the network where the information packet has been, and displaying a map showing a communication path in the network, the communication path being defined by the at least one address. A machine readable medium can include software for causing a computing device to perform the exemplary method. An exemplary system for monitoring streaming media flow in a computer network includes a processor configured to a) receive an information packet, b) collect at least one address recorded in the information packet where each of the at least one address identifies a location in the network where the information packet has been, and c) form a representation of a communication path defined by the at least one address, and includes a display for receiving the representation of the communication path in the network, and for displaying a map showing the communication path in the network. An exemplary system for monitoring streaming media flow in a computer network includes means for recording at least one address in an information packet, each at least one address corresponding to a location in the network where the information packet has been, and includes means for displaying a map showing a communication path in the network, the communication path being defined by the at least one address.

### BRIEF DESCRIPTION OF THE DRAWINGS

Other objects and advantages of exemplary embodiments will become apparent to those skilled in the art from the following detailed description of preferred embodiments, when read in conjunction with the accompanying drawings wherein like elements have been designated with like reference numerals and wherein:

FIG. 1 illustrates a process of media stream discovery in accordance with an exemplary embodiment.

FIG. 2 shows a map display of streaming media paths in a network in accordance with an exemplary embodiment.

FIG. 3 shows a structure and technique for detecting streaming media paths in a network in accordance with an exemplary embodiment.

FIG. 4A shows an exemplary IP packet.

FIG. 4B shows exemplary contents 404 of an option field in a header of the IP packet of FIG. 4A.

FIG. 5 shows an exemplary method Initialize that can be performed by an IP listener in an exemplary embodiment.

FIG. 6 shows an exemplary method Collection that can be performed by an IP listener in an exemplary embodiment.

FIGS. 7A-7B show an exemplary method Build Path that can be performed by an IP listener in an exemplary embodiment.

FIG. 8 shows an exemplary method Path Upload that can be performed by an IP listener in an exemplary embodiment.

FIG. 9 shows an exemplary method Main that can be performed by an a central management system in an exemplary embodiment.

FIGS. 10A-10B show an exemplary method Listener Path Upload that can be performed by a central management system in an exemplary embodiment.

### DETAILED DESCRIPTION OF THE EXEMPLARY EMBODIMENTS

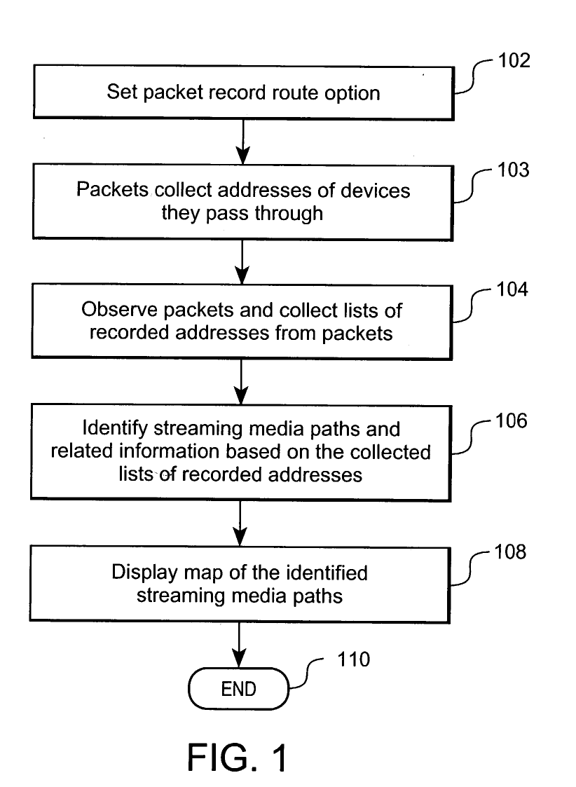

FIG. 1 illustrates an exemplary process of media stream discovery in a computer network such as a Content Delivery Network (CDN). In accordance with exemplary embodiments, in a first step 102 an option is set for packets leaving an origin within a network, so that the packets will record the addresses of devices they pass through as they traverse the network. In step 103, the packets record the addresses of devices they pass through. For example, each packet can record the IP (Internet Protocol) addresses of routers and gateways it passes through. In another embodiment, the option is not set, and the packet contains an address of its origin within the network. A next step 104 includes observing packets and collecting one or more IP addresses from the packets, where the IP addresses correspond to origins of the packets and routers and gateways that the packets have passed through on their way from the origins through the network. A next step 106 includes identifying streaming media communication paths based on the collected lists of recorded addresses, and a subsequent step 108 includes displaying a map of the identified streaming media communication paths. After step 108, the process ends at step 110.

As referenced herein, a CDN can be a system of distributed content on an intranet or the public Internet in which content is replicated and cached throughout the network. When content is replicated throughout a network, users at different locations have quicker access to it than if it resides on one Web site. CDNs can be provided, for example, by content delivery organizations such as Akamai, by large Internet Service Providers (ISPs) or by large enterprises. Specifically, a CDN can be implemented as an overlay to a traditional internet protocol (IP) network, and can for example operate based on Layers 4-7 of the IP protocol stack. Layers 1-7 are defined in accordance with the International Organization for Standardization (ISO) model. A discussion of computer network protocols and layers of the ISO model is discussed, for example, in “Interconnections, Second Edition,” by Radia Perlman (Addison-Wesley, 2000), the disclosure of which is incorporated herein by reference in its entirety.

In accordance with exemplary embodiments, the streaming media communication paths are defined and/or shown at the Layer 3 of the ISO model.

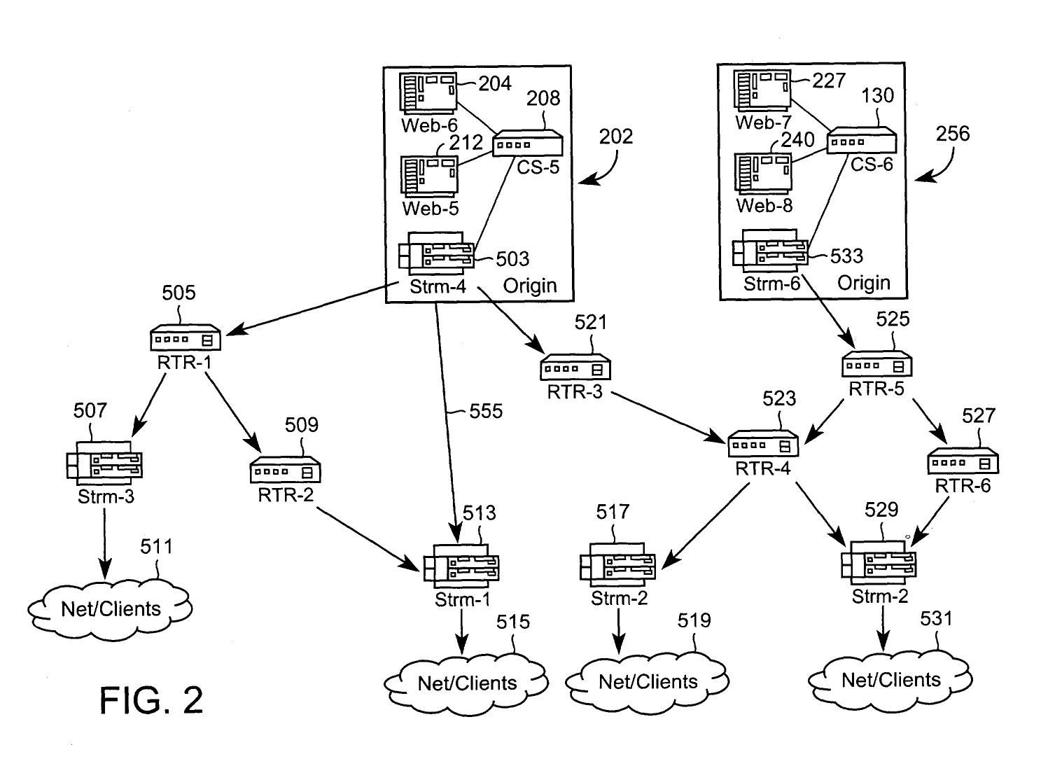

In accordance with an exemplary embodiment, streaming media communication paths within or through a network can be discovered using the steps of FIG. 1 and displayed in a map display. A map display of streaming media communication paths in accordance with an exemplary embodiment is shown in FIG. 2.

FIG. 2 shows an origin 202 including a content switch 208 (CS-5), a webserver 204 (Web-6), a webserver 212 (Web-5) and a stream server 503. FIG. 2 also shows an origin 256 including a content switch 130 (CS-6), a web server 227 (Web-7), a web server 240 (Web-8), and a stream server 533 (Strm-6) In FIG. 2, a first communication path extends from the stream server 503 in the origin 202, to a router 505. From the router 505 are two communication paths, one extending to a stream server 507 and onward from the stream server 507 to a network 511 with clients, and the other extending sequentially to a router 509, a stream server 513 and a network 515 with clients. The networks 511, 515 can be networks external to the origin 202.

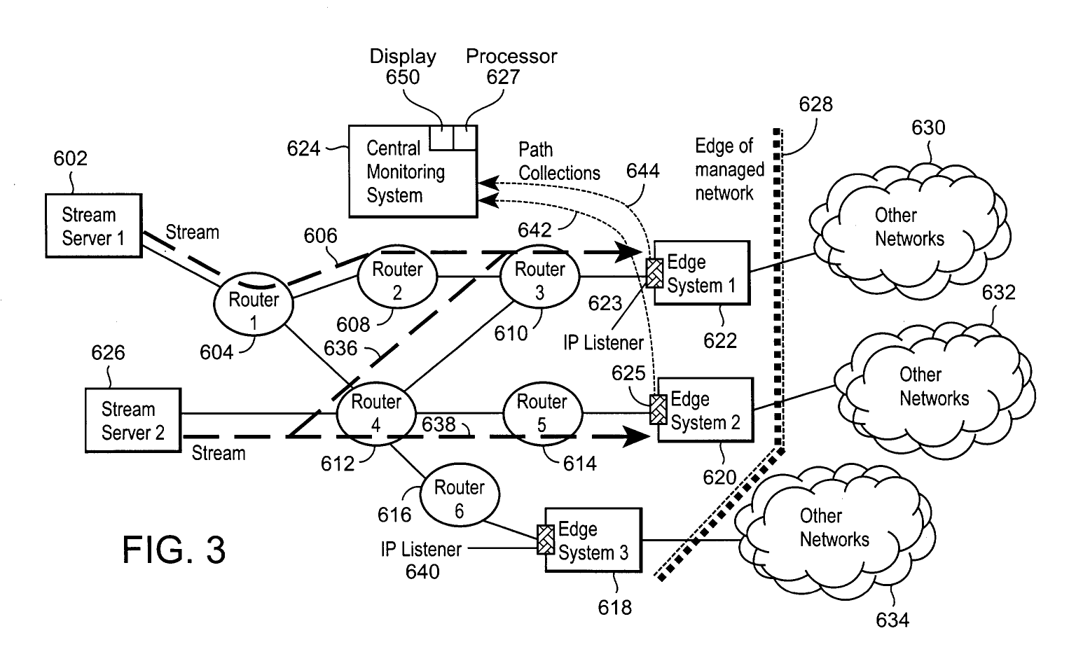

The media stream flowing along the path between the router 505 and the stream server 507 can be the same as the media stream flowing along the path between the router 505 and the router 509, so that the media stream flowing from the stream server 503 to the router 505 is split when it departs the router 505. Alternatively, media streams flowing to the stream servers 507, 513 can be different, for example so that two different media streams both flow from the from the stream server 503 to the router 505, but take different communication paths after departing the router 505. This applies in the same way to other communication paths shown in FIGS. 2-3, wherever paths branch.

FIG. 2 shows a second communication path beginning from the stream server 503 and flowing sequentially through a router 521 to a router 523. From the router 523 two communication paths are shown, one extending through a stream server 517 to a network 519 with clients, and the other extending or flowing through a stream server 529 to a network 531 with clients.

FIG. 2 shows a communication path beginning from a stream server 533 in the origin 256. This communication path flows from the stream server 533 to a router 525, and from the router 525 two communication paths are shown. A first communication path extends from the router 525 sequentially through a router 527 and the stream server 529 to the network 531. The second communication path flows or extends from the router 525 to the router 523. From the router 523 two communication paths are shown. A first communication path flows from the router 523 through the stream server 529 to the network 531, and a second communication path flows or extends from the router 523 through the stream server 517 to the network 519.

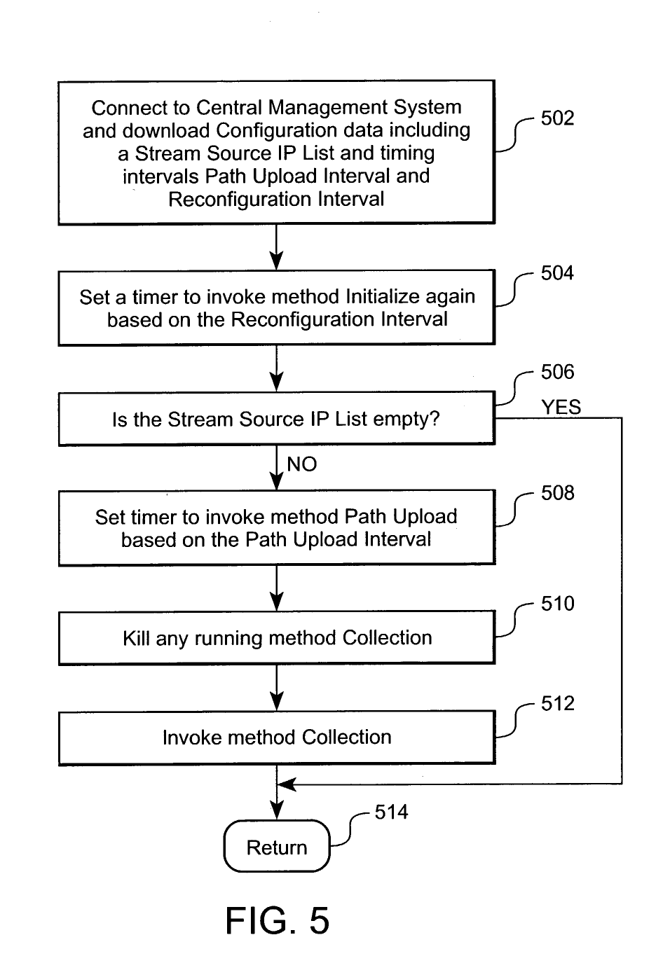

FIG. 2 also shows a path 555, between the stream server 503 and the stream server 513. As explained further below, for example with respect to FIGS. 5-10, this can indicate that the stream server 503 is the stream origin and the stream server 513 is the exit point/exit interface of the stream from the network, where intermediate stream waypoints are not known. The waypoints may be unknown, for example, because a packet containing streaming media but without a Record Route option activated or set, originated at the stream server 503 and was detected by an IP listener (described further below with respect to FIG. 3) in the stream server 513. The stream servers 507, 513, 517, 529 can each include an IP listener.

In accordance with exemplary embodiments, a user can select any of the items shown in the map display (for example, the map display shown in FIG. 2) to obtain another display showing more information about the selected item. The user can, for example, select an item by guiding a mouse to place a pointer or cursor on an item, and then right-clicking to select the item under the pointer.

The streaming media paths shown in FIG. 2, can be discovered using an exemplary system and technique shown in FIG. 3, which implements steps shown in FIG. 1. FIG. 3 shows a system for monitoring streaming media flow in a computer network, including a processor (for example any or all of the edge systems 620, 622, 618 and a processor 627 in the central monitoring system 624) configured to receive an information packet, and collect addresses recorded in the information packet, where the addresses identify locations in the network through which the information packet has passed. The processor can form a representation of a communication path defined by the addresses. The system also includes a display 650 for receiving the representation of the communication path in the network, and for displaying a map showing the communication path in the network. For example, the display 650 can be part of the central monitoring system 624.

In accordance with an exemplary embodiment, the processor can include a first processor (e.g., one or more of the edge systems 618, 620, 622) configured to receive an information packet and collect addresses recorded in the information packet, where the addresses identify locations in the network through which the information packet has passed. The processor can also include a second processor (e.g., the processor 627) configured to receive the collected addresses from the first processor and to provide communication path information based on the collected addresses to the display (e.g., the display 650).

This technique uses an IP (Internet Protocol) Record Route option at the Layer 3 of a network complying with the ISO model, for example as described in section 7.8.1 entitled “Record Route Option” in Internetworking with TCP/IP, by Douglas Corner, published by Prentice Hall, 1988-1991, ISBN 0134701542, or a similar mechanism available via other communication protocols in use within the network, in combination with a series of listeners and some management station processing. The Record Route option can be invoked to cause IP packets in a media stream to record the IP addresses of routers and gateways they pass through or transit. Listeners collect the recorded IP addresses from IP packets (for example, packets leaving the network). The listeners can be located near or at an outer boundary of the network, or at any desired location(s), within the network or outside it. A packet's list of recorded IP addresses indicates the path it took through the network, and in this way the streaming media pathways through the network can be discerned.

The Record Route option can be enabled by the sending application, for example by the streaming servers 503, 533 in the origins 202, 256 shown in FIG. 2, or by the streaming servers 602, 626 shown in FIG. 3. Once this option is enabled, each data packet can record the IP address of each router or gateway it passes through, in its packet header.

Thus, packets flowing along the streaming media path 606 extending from the stream server 602 through the router 604, the router 608 and the router 610, can record the addresses of these routers. Packets flowing along the streaming media path 636 extending from the stream server 626 through the router 612, and the router 610 can record the addresses of these routers 612, 610. Packets flowing along the streaming media path 638 extending from the stream server 626 through the router 612 and the router 614 can record the addresses of these routers 612, 614. A router 616 connected between the router 612 and an edge system 618 having an IP listener 640 are also shown in FIG. 3, as well as other networks 630, 632 and 634 connected respectively to edge systems 622, 620 and 618 through an outer boundary 628 of the network containing the communication paths 606, 636, 638.

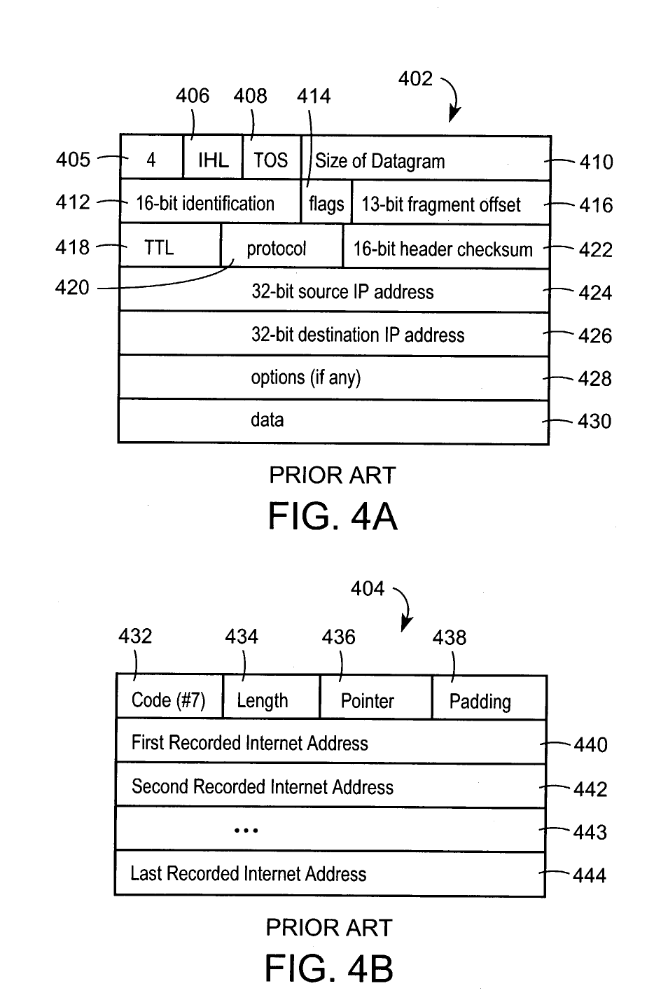

FIG. 4A shows an exemplary IP packet 402, and FIG. 4B shows exemplary contents 404 of an option field 428 of a header of the IP packet 402, that can set or activate the Record Route option.

In the IP packet 402 includes a header comprising the fields 405-428. The field 405 indicates the version number of the Internet Protocol. The field 406 includes an IP header length, and can be formed as a number of 32-bit words, five for example. The field 408 indicates Type of Service, also known as Differentiated Services Code Point (DSCP), and can be set to zero or can indicate particular Quality of Service needs of or from the network. The field 410 indicates a size of the datagram (header+data) in bytes. The field 412 contains an identification code, for example a 16-bit number which together with the source address of the packet (field 424) uniquely identifies the packet and can be used to re-assemble messages or datagrams fragmented into multiple packets. Field 414 includes flags which are used to control whether routers are allowed to fragment a packet, and to indicate parts of a fragmented packet to a receiver. Field 416 indicates fragment offset, which is used when IP router fragmentation is performed. Field 418 indicates a “Time To Live” for the packet 402, or a maximum number of network hops/links that a packet may be routed over. It is decremented by most routers, and is used to prevent accidental routing loops. The field 420 indicates a type of transport protocol to be used, and the field 422 includes a checksum for use in detecting any corruption of the IP header. Packets with an invalid checksum are discarded by all nodes in an IP network. Field 424 includes an address of the original sender of the packet, for example a sending node, and the field 426 indicates an address of a destination node to which the packet 402 is being sent. Field 428 includes any option information, for example Record Route option information. Field 430 contains data associated with the IP packet header, which together with the IP packet header makes up the packet 402.

The option field 428 can include the subfields shown in FIG. 4B, which set the record route option and accept accumulating information about the route or waypoints which the packet 402 follows as it traverses a network or networks. Specifically, a first subfield 432 includes a code invoking or indicating the record route option. A subfield 434 indicates a number of IP addresses that can be stored in the options field 428 (e.g. a maximum number of address subfields 440, 442, 443, 444, etc.). Subfield 436 contains a pointer, for example to a subfield containing the last recorded Internet address or a subfield that can contain the next Internet address that will be encountered. For example, the value in the pointer subfield is incremented by each router or gateway that the IP packet passes through. The subfield 438 can include padding.

In accordance with exemplary embodiments, IP listeners such as the IP listeners 623, 625, 640 are provided. Each IP listener can be an agent implemented in hardware and/or software at any desired or appropriate location, for example in a system or processor such as the edge systems 622, 620, 618 within the network and near an outer boundary 628 of the network as shown in FIG. 3, and/or in the stream servers 507, 513, 517, and 529, to observe packets flowing through a physical and/or logical component of the network. For example, in a configuration where the IP listener is implemented on a component, forms the component, or is able to remotely monitor the component, the IP listener can observe the packets flowing through the component.

In an exemplary embodiment, each of the IP listeners 623, 625, 640 observes packets flowing through it and detects packets having both a) the Record Route option set, and b) a Streaming Protocol designated as the IP ULP (Upper Layer Protocol). From each such detected packet, the listener 623, 625, 640 collects the recorded list of IP addresses, and then adds a) the source IP address to the front of the list, and b) its own IP address to the end of the list, to form a list indicating a stream or communication path beginning at the origin and ending at the listener 623, 625. The listener 623, 625, 640 can gather data from packets it detects and then at the end of a periodic time interval or when it has gathered a specific amount of data, the listener 623, 625, 640 can send the collected data to a central monitoring system. For example, FIG. 3 shows collection paths 644, 642 from the listeners 623, 625 respectively to the central monitoring system 624, via which the listeners forward the collected data. Since a communication path or stream is not present through the edge system 618, a collection path from the listener 640 is not shown.

In accordance with exemplary embodiments, streaming media flow in a computer network is monitored by recording at least one address in an information packet, each at least one address corresponding to a location in the network where the information packet has been, and displaying a map showing a communication path in the network, the communication path being defined by the at least one address. This covers situations where the Record Route option (or any other mechanism that causes a packet to record names and/or addresses of locations within the network where it has been or passed through) is set, and also situations where it is not set. For example, in situations where the Record Route option is not set in an IP packet, the header of the IP packet can include the IP address of the packet's origin within the network, for example an address of a streaming media server. This origin address, together with the network location or IP address of a listener that detects the packet, generally indicates a path of the packet through the network.

FIGS. 5-10 show methods for implementing various features of exemplary embodiments, for example in the listeners 623, 625, 640 and the central monitoring system 624. The methods or logics can be implemented in a variety of programming styles (for example Structured Programming, Object-Oriented Programming, and so forth) and in a variety of different programming languages (for example Java, C, C++, C#, Pascal, Ada, and so forth).

FIG. 5 shows a method Initialize that is performed within a listener, for example within the listeners 623, 625, 640. In block 502, the listener connects to a Central Management System (e.g., the Central Monitoring System 624) and downloads configuration data, including for example a Stream Source IP List and timing intervals Path Upload Interval and Reconfiguration Interval. The Path Upload Interval is a time interval to wait between sending a set of discovered paths, or a set of path objects corresponding to discovered unique paths, as discussed further below, to the Central Management System. In an exemplary embodiment, the set of path objects includes only path objects that have been created during the latest Path Upload Interval. The Reconfiguration Interval is a time interval that the IP listener uses to reload the configuration information from the Central Management System. The Reconfiguration Interval can be, for example greater than or equal to the Path Upload Interval.

The configuration data can be downloaded using any appropriate mechanism, including for example RMI (Remote Method Invocation), CORBA (Common Object Request Broker Architecture (Object Management Group)), Sockets, FTP (File Transfer Protocol), and so forth. The Central Management System can include software running on a computing system that processes the set of path objects corresponding to discovered paths, and generates a visual representation of the information, as shown for example in FIGS. 2 and 3. A path object is a data structure that contains a path (e.g., a list or sequence of IP addresses) and a counter for the number of times the path was encountered.

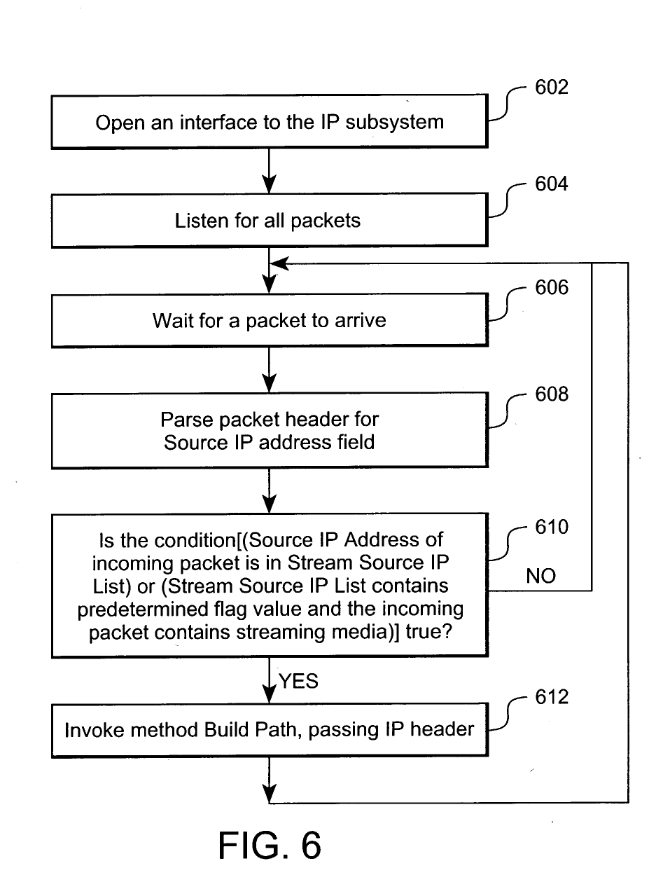

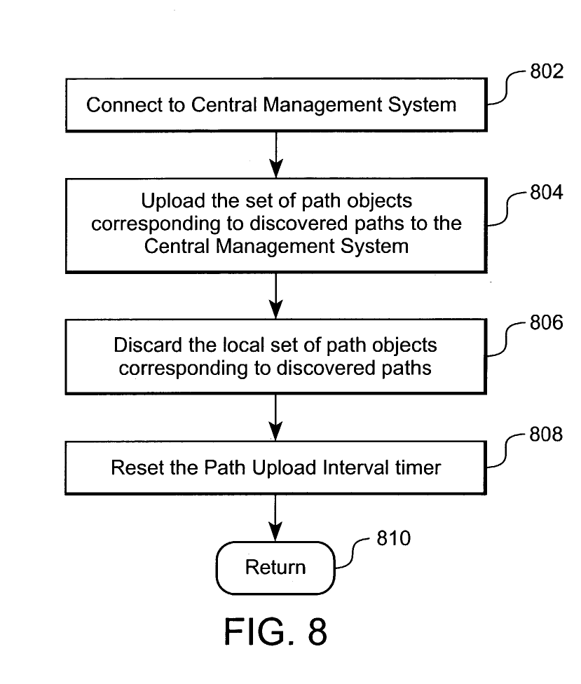

In block 504, a timer is set to invoke the method Initialize again based on the reconfiguration interval received in the configuration data download. The timer can be implemented within or without the listener. In block 506, a determination is made whether the Stream Source IP List is empty. If yes, then in block 514 control is returned to whatever entity or method invoked the method Initialize. If no, then in block 508 a timer is set to invoke a method Path Upload (described below with reference to FIG. 8) based on the Path Upload Interval. This timer can be implemented within or without the listener, and when the timer expires the method Path Upload will be invoked. From block 508 control proceeds to block 510, where any running method Collection (described below with respect to FIG. 6) is killed. From block 510 control proceeds to block 512, where the method Collection is invoked. From block 512, control proceeds to block 514, where it is returned to whatever entity or method invoked the method Initialize.

FIG. 6 shows a method Collection that is performed within a listener, for example within the listeners 623, 625, 640, and which can be invoked from the method Initialize.

In block 602, an interface is opened to an IP subsystem, for example an edge system such as the edge systems 622, 620, 618 associated with the listeners 623, 625, 640. In block 604, packets are listened for. In block 606, waiting is performed until a packet arrives. In block 608, when a packet arrives the header of the packet is parsed for a Source IP address field. Other actions can also be performed in block 608, for example the packet can be examined to determine whether it contains streaming media. This can be done, for example, by determining whether the protocol field 420 in the packet's header is set up properly or otherwise contains information indicating presence of streaming media, by evaluating some or all of the data in the packet (for example, in the data field 430) to discern whether the data is streaming media, or via any mechanism suited to indicate presence of streaming media (or desired information) in the packet.

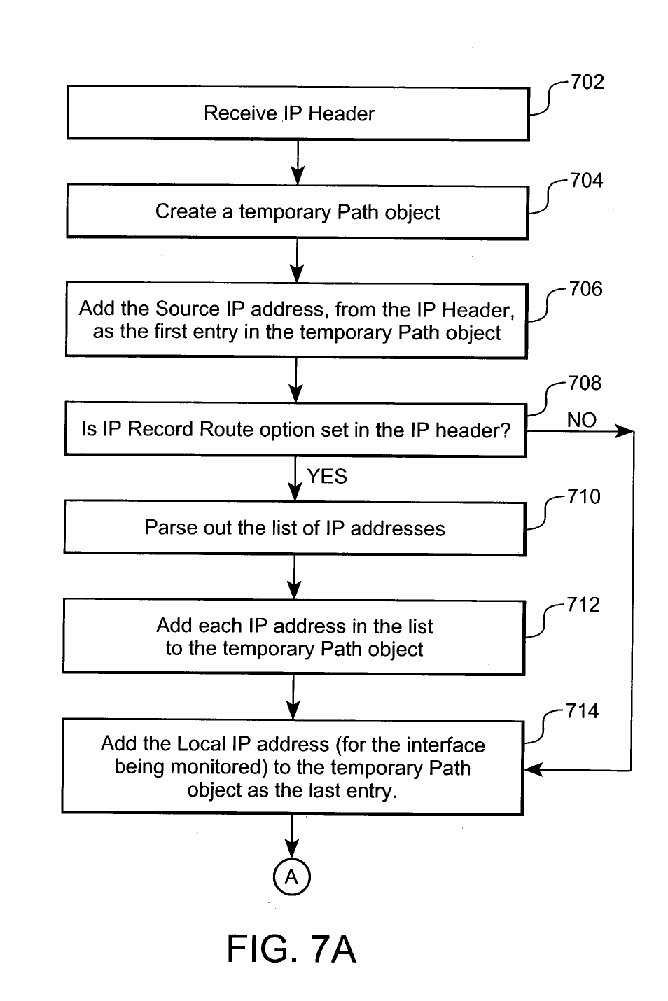

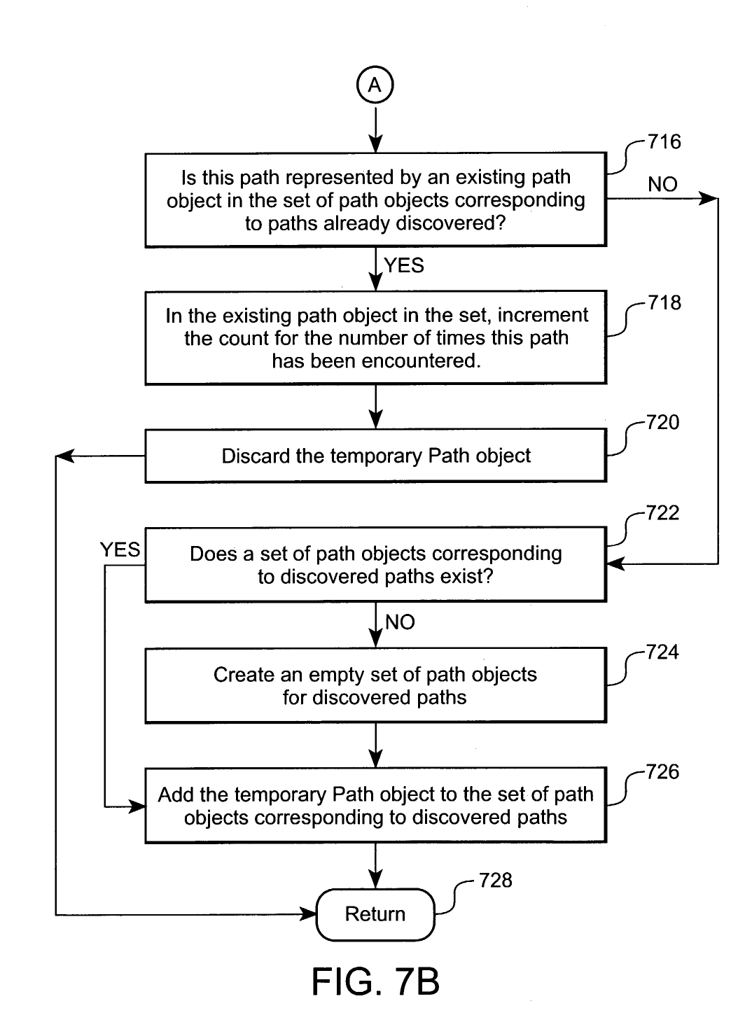

In block 610, the condition or logic expression [(Source IP Address of incoming packet is in Stream Source IP List) or (Stream Source IP List contains a predetermined flag value and the incoming packet contains streaming media)] is evaluated. If the condition is logically true, then in block 612 the method Build Path (described below with respect to FIGS. 7A-7B) is invoked, the IP header is passed with the invocation. If the condition is logically false, then control goes back to block 606.

The predetermined flag value in block 610 can be, for example, 255.255.255.255, or any other recognizable flag or value. For example, when the Stream Source IP List contains the predetermined flag value and the incoming packet contains streaming media, then information in the packet will be processed by the method Build Path. As can be seen from block 610, if the incoming packet originated at a source whose IP address is in the Stream Source IP List, then information in the packet will be processed by the method Build Path. The Stream Source IP List can include, for example, IP addresses of stream servers. An empty Stream Source IP List implies “do not listen”.

FIGS. 7A-7B show the method Build Path that is performed within a listener, for example within the listeners 623, 625, 640, and which can be invoked from the method Collection.

In block 702, an IP header is received, for example from whichever entity or method invoked the method Build Path. In block 704, a temporary Path object is created. In block 706, the Source IP address from the received IP header is added into the temporary Path object. In block 708, a determination is made whether the Record Route option is set in the IP header. If no, then control proceeds to block 714. If yes, then control proceeds to block 710 where the list of IP addresses in the IP header (collected for example in accordance with the set Record Route option) is parsed out. From block 710 control proceeds to block 712, where each of the IP addresses in the list is added to the temporary Path object.

In block 714, the Local IP address, for example the address of the interface being monitored by the listener, (e.g., addresses of the edge systems 622, 620, 618), is added to the temporary Path object as the last entry or path waypoint.

In block 716, a determination is made whether the path represented by the sequence of IP addresses in the temporary Path object is represented by an existing path object in a set of path objects corresponding to paths already discovered. The listener can maintain the set of path objects. If the determination is negative, then control proceeds to block 722.

If the determination is positive, then control proceeds from block 716 to block 718 where in the existing object in the set, the count for the number of times that the path has been encountered (or traversed by a packet) is incremented. From block 718 control proceeds to block 720, where the temporary Path object is discarded. From block 720 control proceeds to block 728, where the method Build Path returns control to the entity or method that invoked it.

In block 722, a determination is made whether a set of path objects corresponding to discovered paths, exists. If yes, then control proceeds to block 726. If no, then control proceeds to block 724, where an empty set of path objects for discovered paths, is created. From block 724, control proceeds to block 726.

In block 726, the temporary path object is added to the set of path objects corresponding to discovered paths. From block 726, control proceeds to block 728, where the method Build Path returns control to the entity or method that invoked it.

FIG. 8 shows the method Path Upload that is performed within a listener, for example when the Path Upload Interval timer loaded with the Path upload interval times out or fires.

In block 802, the listener connects with the Central Management System (e.g., the Central Monitoring System 624). In block 804, the set of path objects corresponding to discovered paths is uploaded to the Central Management System. In block 806, the local set (e.g., the set maintained by the listener) of path objects corresponding to discovered paths, is discarded or made into an empty set. In block 808, the Path Upload Interval timer is reset. In block 810, the method Path Upload returns control to the entity or method that invoked it.

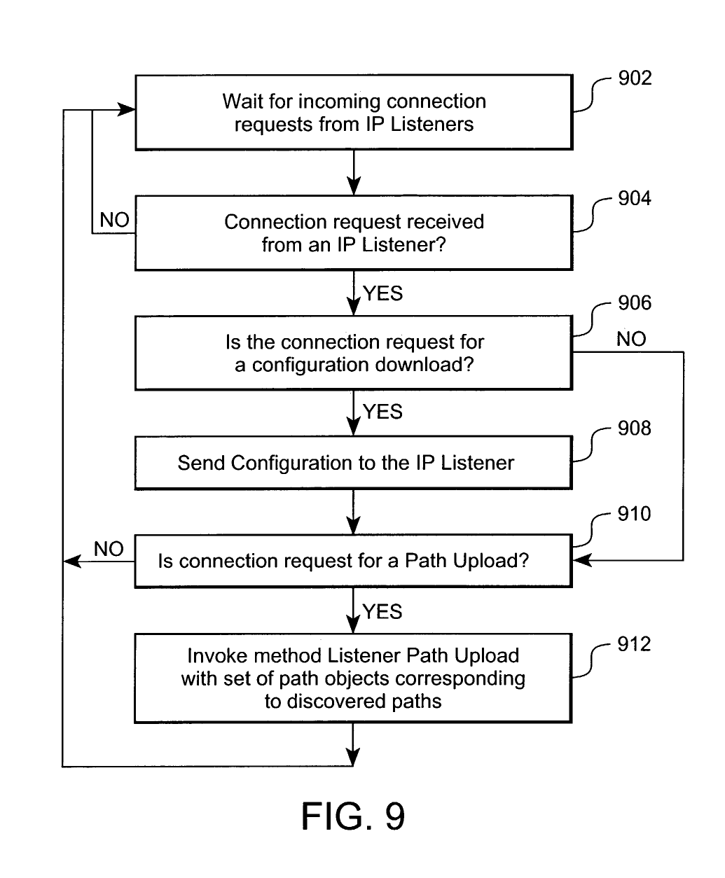

FIG. 9 shows a method Main that is performed within the Central Management System (e.g., the Central Monitoring System 624).

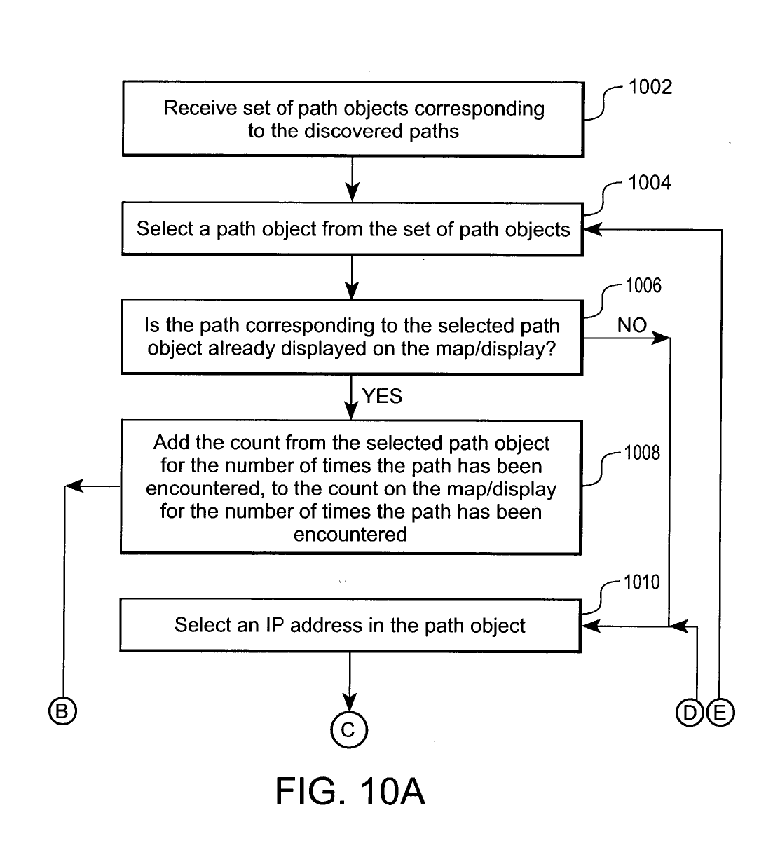

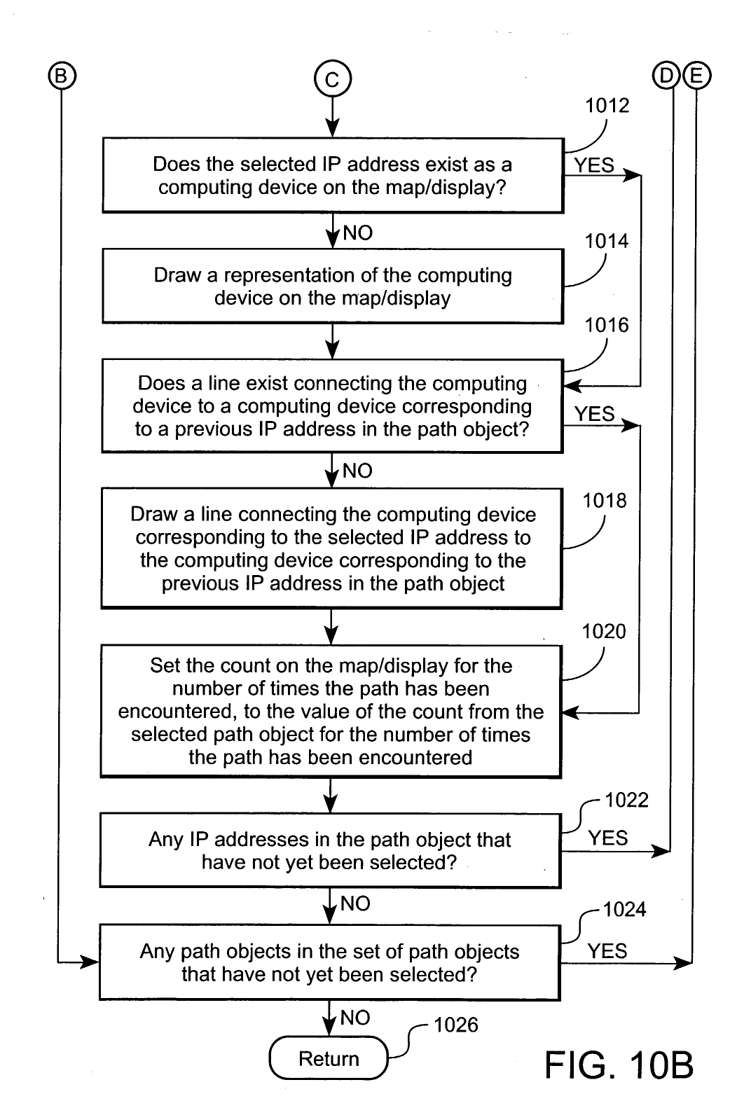

In block 902, the Central Management System waits for incoming connection requests from IP listeners. In block 904, a check is made whether a connection request has been received from an IP listener. If no, then control returns to block 902. If yes, then control proceeds to 906. In block 906, a determination is made whether the connection request is for a configuration download. If no, then control proceeds to block 910. If yes, then control proceeds to block 908. In block 908, configuration information is sent to the IP Listener. From block 908 control proceeds to block 910, where a determination is made whether the connection request includes a request for a Path Upload. If no, then control returns to block 902. If yes, then control proceeds from block 910 to block 912, where the set of path objects corresponding to discovered paths is received as an upload from the listener, and the method Listener Path Upload (described with respect to FIGS. 10A-10B) is invoked with the set received from the listener (in other words the set is passed to the method Listener Path Upload). From block 912, control returns to block 902.

FIGS. 10A-10B shows a method Main that is performed within the Central Management System (e.g., the Central Monitoring System 624).

In block 1002, set of path objects corresponding to the discovered paths is received. In block 1004, a path object from the received set is selected. In block 1006, a determination is made whether the path corresponding to the selected path object is already displayed on the map/display (e.g. as in FIG. 2, or on the display 625 of FIG. 3).

If yes, then control proceeds to block 1008, where the count from from the selected path object for the number of times the path has been encountered, is added to the count on the map/display for the number of times the path has been encountered. From block 1008, control proceeds to 1024, where a determination is made whether there are any path objects in the set that have not yet been selected. If yes, the control returns to block 1004. If no, then control proceeds to 1026, where control is returned to the method or entity that invoked the method Listener Path Upload.

If the determination in block 1006 is negative, then control proceeds to block 1010, where an IP address is selected from the selected path object. In block 1012, a determination is made whether the selected IP address exists as a computing device on the map/display. If yes, then control proceeds to block 1016. If no, then control proceeds to block 1014, where a representation of a computing device corresponding to the selected IP address is drawn on the map/display. From block 1014, control proceeds to block 1016.

In block 1016, a determination is made whether a line exists on the map/display connecting the computing device to a computing device corresponding to the previous IP address in the selected path object. If yes, then control proceeds to block 1020. If no, then control proceeds to block 1018, where a line is drawn to connect the computing device corresponding to the selected IP address, to the computing device corresponding to the previous IP address in the selected path object. From block 1018 control proceeds to block 1020.

In block 1020, the count on the map/display for the number of times the path has been encountered, is set to the value of the count from the selected path object for the number of times the path has been encountered. From block 1020, control proceeds to 1022, where a determination is made whether any IP addresses in the selected path object have not yet been selected. If yes, then control returns to block 1010. In this way, each IP address in the selected path object can be processed. If the determination in block 1022 is negative, then control proceeds to block 1024.

In block 1024, a determination is made whether any path objects in the set of path objects have not yet been selected. If yes, then control returns to block 1004. In this way, each path object in the set can be processed. If the determination in block 1024 is negative, then control proceeds to block 1026, where control is returned to the method or entity that invoked the method Listener Path Upload.

Information collected by the listeners 623, 625, 640 can be combined, organized and presented in any graphical and/or textual manner which allows the streaming media paths to be visualized and/or deduced. For example, the central monitoring system 624 can process the collected data and then map, or provide refined information with which to map, the streaming media paths in the network in a map display, as for example in FIG. 2. The central monitoring system 624 can include a processor 627 for processing and/or mapping the collected data, and can also include a display 625 for displaying the map. The display can be a Liquid Crystal Display (LCD), a Cathode Ray Tube (CRT) display, or any other display. The map can be shown in the display via a graphical user interface. The processor 627 (and also the edge systems 618, 620, 622) can be a microprocessor, computer, or any other computing device, and can be implemented in hardware and/or software, in a single physical location or in distributed fashion among various locations or host computing platforms.

The central monitoring system can be the system or agent that forms and presents the map displays, or can be a system or agent that cooperates with the system or agent responsible for the map display. Each listener can be a dedicated unit, or can be implemented in software on an existing system hardware resource. In addition, the listener can assign an identifier or label to each unique path, track the frequency or the number of times each unique path is used during the periodic time interval, and provide this information along with the collected data to the central monitoring system. At the end of the periodic time interval, each listener can provide data to the central monitoring system including paths as defined by strings or lists of addresses such as IP addresses, path identifiers, and path counts. The listeners can be organized to report to the central monitoring system at the same time, or to report at staggered times. The listeners can also be organized into groups, where each group reports to the central monitoring system at a different time.

In accordance with exemplary embodiments, the map display provided for example by the central monitoring system 624, can show the waypoints or network elements defining a streaming media communication path in a logical order or arrangement with communication paths between them, as shown for example in FIG. 2. Where geographic locations of the waypoints or network elements are known, for example by the central monitoring system 624, the map display can also display or represent the waypoints or network elements in an order or arrangement that shows their geographical locations, along with logical or geographical routes of the communication paths between them. The map can represent the exact geographical locations, or the relative geographic or physical locations of the elements and/or communication paths between them.

Persons skilled in the art will appreciate that a machine readable medium can include software for causing a computing device to perform the exemplary method(s) and processes described herein.

It will be appreciated by those skilled in the art that the present invention can be embodied in other specific forms without departing from the spirit or essential characteristics thereof, and that the invention is not limited to the specific embodiments described herein. For example, the principles and mechanisms described herein can be applied to monitor flow of any desired type or flow of data in a network, not just streaming media, and can be applied to simultaneously monitor different types or flows of data in a network. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for monitoring streaming media flow in a computer network, the method comprising:
recording at least one address in an information packet, each at least one address corresponding to a location in the network where the information packet has been; and
displaying a map showing a communication path in the network, the communication path being defined by the at least one address.

2. The method of claim 1, wherein the map is displayed via a graphical user interface.

3. The method of claim 1, comprising:
collecting the at least one address from the information packet.

4. The method of claim 3, wherein the of collecting is performed at an outer boundary of the network.

5. The method of claim 3, wherein the at least one address includes addresses of routers and gateways through which the information packet passed.

6. The method of claim 3, comprising:
at the end of a periodic time interval, sending information based on the at least one address to a central monitoring system.

7. The method of claim 6, comprising:
generating the map based on the sent information.

8. The method of claim 6, comprising:
identifying a communication path defined by the at least one address.

9. The method of claim 8, comprising:
labeling the communication path defined by the at least one address.

10. The method of claim 9, wherein the sent information includes path labels.

11. The method of claim 8, comprising:
tracking a frequency at which the identified path is traversed by information packets.

12. The method of claim 11, wherein the sent information includes the frequency.

13. A system for monitoring streaming media flow in a computer network, the system comprising:
a processor configured to a) receive an information packet, b) collect at least one address recorded in the information packet where each of the at least one address identifies a location in the network where the information packet has been, and c) form a representation of a communication path defined by the at least one address; and
a display for receiving the representation of the communication path in the network, and for displaying a map showing the communication path in the network.

14. The system of claim 13, wherein the processor comprises:
a first processor configured to receive an information packet and collect any addresses recorded in the information packet, where the addresses identify locations in the network where the information packet has been; and
a second processor configured to receive the collected addresses from the first processor and to provide communication path information based on the collected addresses to the display.

15. A system for monitoring streaming media flow in a computer network, the system comprising:
means for recording at least one address in an information packet, each at least one address corresponding to a location in the network where the information packet has been; and
means for displaying a map showing a communication path in the network, the communication path being defined by the at least one address.

16. The system of claim 15, comprising:
means for collecting the at least one address from the information packet.

17. The system of claim 16, comprising:
means for sending information based on the at least one address to a central monitoring system, at the end of a periodic time interval.

18. The system of claim 17, comprising:
means for generating the map based on the sent information.

19. The system of claim 17, comprising:
means for identifying a communication path defined by the at least one address.

20. The system of claim 19, comprising:
means for labeling the communication path defined by the at least one address.

21. The system of claim 19, comprising:
means for tracking a frequency at which the identified path is traversed by information packets.

22. A machine readable medium comprising a computer program for causing a computer to:
record at least one address in an information packet, each at least one address corresponding to a location in a network where the information packet has been; and
display a map showing a communication path in the network, the communication path being defined by the at least one address.

23. The medium of claim 22, wherein the computer program causes the computer to:
collect the at least one address from the information packet.

24. The medium of claim 23, wherein the computer program causes the computer to:
send information based on the at least one address to a central monitoring system, at the end of a periodic time interval.

25. The medium of claim 24, wherein the computer program causes the computer to:
generate the map based on the sent information.

26. The medium of claim 24, wherein the computer program causes the computer to:
identify a communication path defined by the at least one address.

27. The medium of claim 26, wherein the computer program causes the computer to:
label the communication path defined by the at least one address.

28. The medium of claim 26, wherein the computer program causes the computer to:
track a frequency at which the identified path is traversed by information packets.
